(19) United States
(12) Patent Application Publication
(10) Pub. No.: US 2026/0178254 A1
(43) Pub. Date: Jun. 25, 2026

(54) OPTIMIZING OBJECT MANUFACTURING VIA AUTOMATIC BUFFER SHUFFLING

(71) Applicant: STARBUCKS CORPORATION, SEATTLE, WA (US)

(72) Inventors: Zachery Aaron Thieme, Maple Valley, WA (US); Harsh Nigam, Renton, WA (US); Ross William Marshall, Shoreline, WA (US); Amy Rose Funk, Seattle, WA (US); Sahana Somasundara, Bothell, WA (US)

(73) Assignee: STARBUCKS CORPORATION, SEATTLE, WA (US)

(21) Appl. No.: 19/357,303

(22) Filed: Oct. 14, 2025

Related U.S. Application Data
(60) Provisional application No. 63/737,946, filed on Dec. 23, 2024.

(51) Int. Cl. G06F 3/12; B41J 3/407

(52) U.S. Cl. CPC G06F 3/1263; B41J 3/4075; G06F 3/1203

(57) ABSTRACT

A system can receive requests of various priorities and store them in a buffer. For each buffered request, the system can execute an iterative buffer shuffling process. During each iteration, the system computes a timing parameter value for the request. If the computed value exceeds a predefined timing threshold, the system evaluates additional timing conditions in relation to the next request immediately preceding the request in the buffer. If those additional timing conditions are also satisfied, the system swaps the places of the two requests in the buffer. This buffer shuffling process can repeat for the request until a condition is satisfied. The equipment can then be controlled to fulfill the requests in the new buffer sequence, which can be more optimal than the original buffer sequence.

### CROSS-REFERENCE TO RELATED APPLICATION

This claims priority under 35 U.S.C. § 119 (e) to U.S. Provisional Patent Application No. 63/737,946, filed Dec. 23, 2024 and titled “OPTIMIZING OBJECT MANUFACTURING VIA AUTOMATIC BUFFER SHUFFLING,” the entirety of which is hereby incorporated by reference herein.

### TECHNICAL FIELD

The present disclosure relates generally to manufacturing objects with equipment. More specifically, but not by way of limitation, this disclosure relates to optimizing manufacturing of objects using equipment by performing automatic buffer shuffling based on dynamically computed parameter values.

### BACKGROUND

Manufacturing facilities and other operational locations are equipped with a variety of physical equipment used to construct and assemble objects. These facilities typically receive a relatively continuous stream of requests for different objects. Such requests are usually processed in the order they are received. This approach, often referred to as first-in-first-out (FIFO), ensures that each request is handled sequentially, allowing for straightforward and predictable operations. The equipment used in these facilities can range from simple tools to complex automated machinery, which can be used together to build objects according to the specified requirements.

### BRIEF DESCRIPTION OF THE DRAWINGS

FIG. 1 shows a block diagram of an example of a system for optimizing object manufacturing via automatic buffer shuffling according to some aspects of the present disclosure.

FIG. 2 shows an example of sub-requests being rearranged in queues according to some aspects of the present disclosure.

FIG. 3 shows a flowchart of an example of a process for automatic buffer shuffling according to some aspects of the present disclosure.

FIG. 4 shows a flowchart of an example of a process for computing parameter values according to some aspects of the present disclosure.

FIG. 5 shows a block diagram of an example of a computing device for implementing some aspects of the present disclosure.

### DETAILED DESCRIPTION

In many operational environments such as manufacturing facilities, a relatively continuous stream of requests is processed to construct objects using equipment. Conventionally, these requests are processed using first-in-first-out (FIFO) approaches, so that the objects are constructed in the sequence in which the corresponding requests are received. But such FIFO approaches have the technical problem in that they fail to consider the priority of different requests or their different timing constraints, which can lead to inefficiencies and suboptimal usage of the equipment.

Certain aspects and features of the present disclosure can overcome the abovementioned problems by optimizing equipment usage in such operational environments, where multiple requests with varying priorities are processed to construct physical objects. This optimization is achieved through an automatic buffer shuffling process, which is an iterative process that can be applied to some or all requests in the buffer. During one round of the dynamic buffer shuffling process, a buffered request is selected. The system computes a timing parameter value for the request and determines a priority of the request. If the computed timing parameter value exceeds a first timing threshold, the system evaluates the timing parameter value for the next request immediately ahead of the request in the buffer. If the timing parameter value for the next request is below a second timing threshold, the system swaps the places of the two requests in the buffer. This process can then be repeated based on the request's new buffer position, moving it incrementally toward the front of the buffer until a condition is satisfied. Once the condition is satisfied, the request is done being evaluated and another buffered request can be selected for evaluation. The buffer shuffling process can then be applied to that request. This can continue until some or all of the requests in the buffer have been evaluated. The equipment can then be controlled to fulfill the requests in the new buffer sequence, which can be better optimized to improve throughput and responsiveness for higher-priority requests while respecting the timing constraints of the lower-priority requests.

By employing the buffer shuffling process, the techniques described herein can effectively overcome the limitations of FIFO approaches. The system can dynamically rearrange requests to make better use of the equipment, while ensuring that both higher-priority and lower-priority requests meet certain timing constraints. This approach not only enhances efficiency but also ensures a more responsive and adaptable system capable of meeting varying demands in real-time.

In some examples, the system can also integrate advanced features such as sensor data analysis and predictive forecasting using machine learning models to further refine the buffer shuffling process. For instance, those advanced features can be used to more accurately compute the timing parameter values. These enhancements can ensure that the system can adapt to changing conditions and demands, providing a robust solution for optimizing equipment usage in diverse operational environments.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

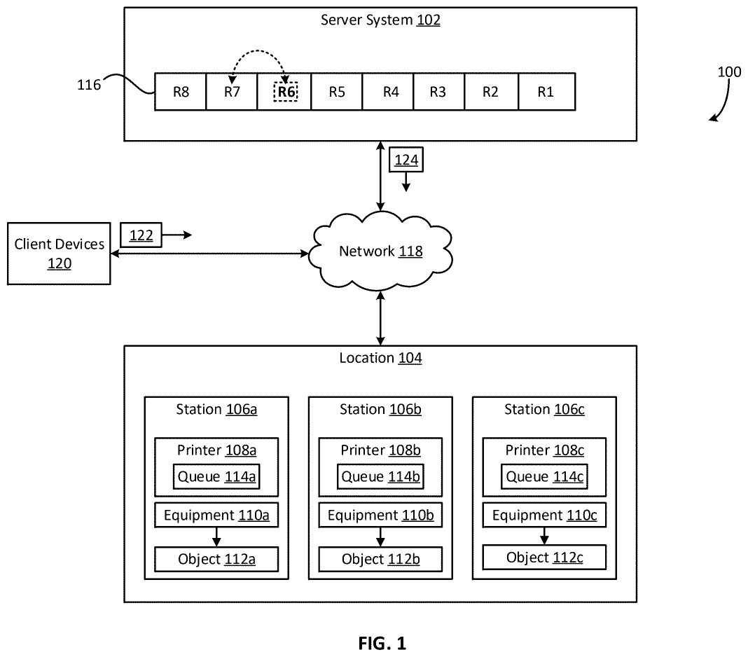

FIG. 1 shows a block diagram of an example of a system 100 for optimizing object manufacturing via automatic buffer shuffling according to some aspects of the present disclosure. The system 100 includes client devices 120 configured to submit requests 122 for objects 112a-c, a server system 102 configured to receive and arrange the requests 122 in a buffer 116, and a physical location 104 such as a store that contains equipment 110a-c for manufacturing the objects 112a-c based on the order of the requests 122 in the buffer 116.

More specifically, the client devices 120 can transmit requests 122 for objects 112a-c to the server system 102 via one or more networks 118, such as a local area network (LAN) and/or the Internet. Examples of the client devices 120 can include mobile phones, smart watches, tablets, desktop computers, laptop computers, kiosks, drive-through terminals that may be positioned at a drive through window, and service counter terminals. Some client devices 120 may be positioned at (e.g., inside) the location 104, while other client devices 120 may be positioned remotely from the location 104. For example, drive-through terminals, kiosks, and service counter terminals can be in fixed positions at the location 104. On the other hand, mobile devices such as smartphones and smartwatches can move in and out of the location 104.

Requests 122 originating from different types of client devices 120 may be transmitted to the server system 102 via different communication channels. For instance, drive-through terminals may transmit requests 122 to the server system 102 via a first communication channel, such as a first endpoint (e.g., API endpoint) which may be configured specifically for such requests. Service counter terminals may transmit requests 122 to the server system 102 via a second communication channel, such as a second endpoint which may be configured specifically for such requests. Mobile devices may transmit requests 122 to the server system 102 via a third communication channel, such as a third endpoint which may be configured specifically for such requests. For instance, mobile devices may execute a mobile application (e.g., a native application) configured to interface with the third endpoint over the network 118, and the third endpoint may be specifically configured for interfacing with the mobile application.

Requests 122 from different sources can be assigned different priorities. In some examples, requests transmitted from client devices 120 positioned at the location 104 may be assigned a higher priority than requests transmitted from devices that are remote from the location 104, or vice versa. For instance, requests originating from client devices 120 at the location 104, such as service counter terminals and drive-through terminals, may be assigned a higher priority than requests originating from outside the location 104. This may allow for users who submit requests while waiting at the location 104 to be prioritized over users who are not yet at the location 104. In some examples, requests 122 can be assigned priorities by the server system 102 based on the communication channel through which they are received. Because service counter terminals and drive-through terminals are fixed at the location 104, their requests may always be assigned higher priority than requests originating from remote devices. In contrast, requests originating from mobile devices may be assigned priorities based on their locations. A mobile device may be assigned a higher priority when it is positioned at the location 104, and a lower priority when it is remote from the location 104. Location data, which can be collected by a global positioning system (GPS) unit of the mobile device, can be transmitted to the server system 102. The server system 102 can then use the location data to determine the mobile device's location at a given point in time to assign it the appropriate priority.

The server system 102 can include one or more computing devices, such as one or more servers or desktop computers. The server system 102 can receive the requests 122 and arrange them in a buffer 116. The buffer 116 can have a head and a tail. The head can be the front of the buffer 116 and correspond to the request to be handled soonest. The tail can be the end of the buffer 116 and correspond to the request to be handled last.

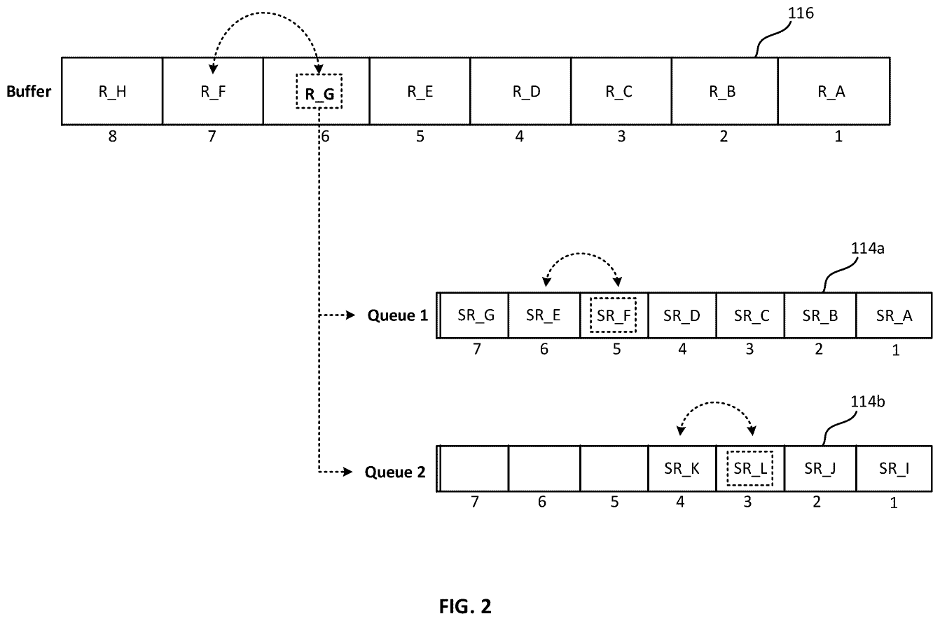

To determine how to organize the requests 122 in the buffer 116, the server system 102 can execute a buffer shuffling process. An example of the buffer shuffling process is described in greater detail later with respect to FIG. 2, but generally, the buffer shuffling process can involve iteratively rearranging the requests 122 in the buffer to ensure that most or all of the requests satisfy their respective timing constraints, which can be determined based on their respective priorities. By executing the buffer shuffling process, the order of the requests 122 is changed from first-in-first out (FIFO) to a different sequence that is more optimal. This can help improve the effectiveness of the system 100.

The buffer shuffling process can be repeated over time as requests are streamed to the server system 102. For example, the server system 102 can automatically repeat the buffer shuffling process each time the server system 102 receives one or more new requests from one or more client devices 120. In this way, the buffer's organization can be updated in real-time based on new requests. This can help ensure that the buffer's organization remains optimal as conditions and demands change in real time with respect to the location 104.

Each individual request 122 can specify one or more objects to be manufactured at the location 104. Once a request 122 has been assigned a position in the buffer 116, the request's constituent objects can be manufactured based on the request's position in the buffer 116. The objects can be manufactured at the various stations 106a-c in the location 104. The stations 106a-c can be configured to manufacture different objects or perform different steps in the manufacturing of a single object. Each of the stations 106a-c is equipped with equipment 110a-c, such as mixers, shakers, coffee machines, conveyor belts, ice machines, fluid dispensers, foam dispensers, refrigerators, cutters and cutting machines, and presses. The equipment 110a-c can be used to manufacture the one or more objects in a given request 122.

In some examples, the server system 102 can decompose a main request 122 into its constituent objects, generate sub-requests for manufacturing the objects, and transmit the sub-requests to the appropriate stations 106a-c. Because each of the stations 106a-c can be configured for manufacturing a specific type of object, the server system 102 can forward a sub-request for a particular type of object to the station configured to manufacture that type of object. Each of the stations 106a-c can have a respective queue 114a-c for storing the sub-requests. For example, station 106a can be configured for manufacturing a first type of object 112a, such as a cold beverage. Station 106a can have a first queue 114a that stores sub-requests for the first type of object 112a in a first sequence. Similarly, station 106b can be configured for manufacturing a second type of object 112b, such as a hot beverage. Station 106b can have a second queue 114b that stores sub-requests for the second type of object 112b in a second sequence. Station 106c can be configured for manufacturing a third type of object 112c, such as a food item. Station 106c can have a third queue 114c that stores sub-requests for the third type of object 112c in a third sequence. The equipment at each station can be used to manufacture its assigned objects in the sequence designated by the corresponding queue. For example, equipment 110a can be used to create cold beverages in the order of the corresponding sub-requests in the first queue 114a, equipment 110b can be used to create hot beverages in the order of the corresponding sub-requests in the second queue 114b, and equipment 110c can be used to create food items in the order of the corresponding sub-requests in the third queue 114c.

In some examples, the queues 114a-c may be print queues. The print queues may be stored in the internal memories of printers 108a-c located at the stations 106a-c. In some such examples, each sub-request can be a print job for printing a label for the corresponding object, which is to be manufactured at the corresponding station. The label may be a text label with descriptive information about the object. The sub-requests in a queue 114a can thus correspond to a sequence of print jobs for printing labels for the corresponding objects. At each of the stations 106a-c, the corresponding printers 108a-c can print out the labels in the sequence defined by the corresponding queues 114a-c. The equipment 110a-c can then be used to manufacture the objects 112a-c in that same sequence.

In some examples, the way in which sub-requests are organized in a particular queue 114a can be changed based on the buffer shuffling process. For example, the positions of two main requests (e.g., R6 and R7) in the buffer 116 may be swapped based on the buffer shuffling process, as represented by the dashed arrow in FIG. 1. This may necessitate a change in the positions of two sub-requests in the queue 114a. For instance, if the first main request included a first object and the second main request included a second object, and the first object previously preceded the second object in the queue 114a, the objects' positions in the queue 114a may need to be switched if the first and the second main requests are swapped in the buffer 116. To that end, the server system 102 can notify the station 106a of the change and, in response, the change can be made to the queue 114a. For example, the server system 102 can transmit a notification 124 of the change to the printer 108a, which can update the queue 114a in response to the notification. A similar process can be performed for other objects associated with the first and second main requests. For example, the server system 102 can also transmit notifications to the other stations 106b-c (e.g., printers 108b-c) to update their respective queues 114b-c, based on the first and second main requests switching positions in the buffer 116. Through this process, the buffer 116 and the various queues 114a-c can be dynamically rearranged in real time based on incoming requests 122 to improve the effectiveness of the system 100.

One example of sub-requests being reorganized in their queues is shown in FIG. 2. As shown, the server system 102 may reorganize the buffer 116 by switching the positions of Request F (“R_F”) and Request G (“R_G”). Before the switch, R_F may have been ahead of R_G in the buffer but, following the buffer shuffling process, their positions may be switched such that R_G is now ahead of R_F in the buffer, as shown. Based on this reorganization, it may also be desirable or necessary to reorganize one or more queues 114a-b related to the objects specified in R_F and/or R_G. To that end, the server system 102 can transmit one or more notifications to reorganize those queues 114a-b. This can cause their sub-requests to be rearranged as shown. For example, the positions of Sub-Request E (“SR_E”) and Sub-Request F (“SR_F”) may be switched in the first queue 114a, to arrive at the arrangement shown in FIG. 1. Additionally or alternatively, the positions of Sub-Request K (“SR_K”) and Sub-Request L (“SR_L”) may be switched in the second queue 114b, to arrive at the arrangement shown in FIG. 1. After the queues 114a-b have been rearranged, the objects in each of the queues 114a-b can be manufactured in their queued sequence. In some examples, once the manufacturing of an object has begun, its position in its queue may remain fixed and may not be able to be changed.

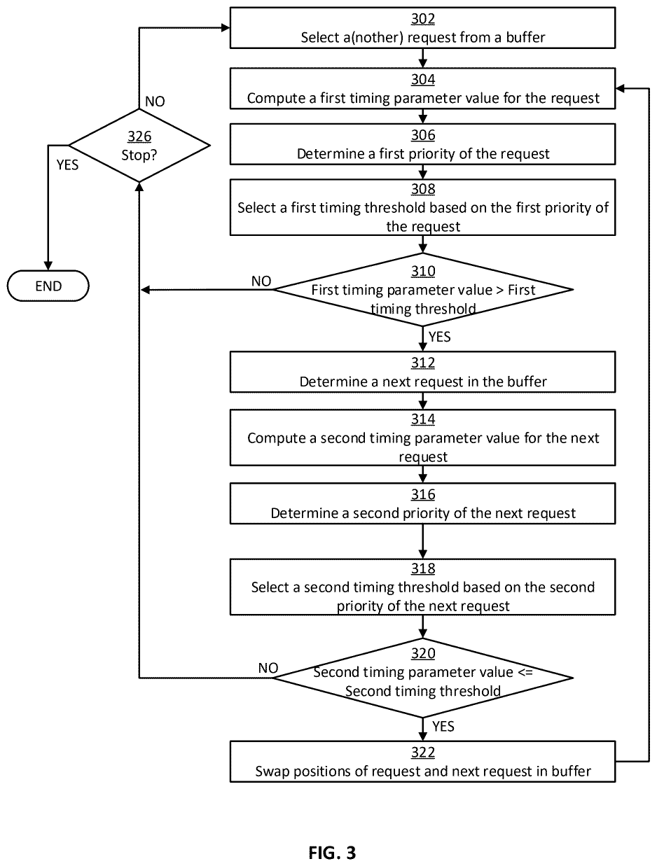

Turning now to FIG. 3, shown is a flowchart of an example of a process for automatic buffer shuffling according to some aspects of the present disclosure. Other examples may involve more operations, fewer operations, different operations, or a different sequence of operations than is shown in FIG. 3. The operations of FIG. 3 are described below with respect to the components of FIG. 1 described above.

In block 302, the server system 102 selects a request 122 from the buffer 116. In some examples, the request 122 that is selected may be the most recent request received by the server system 102.

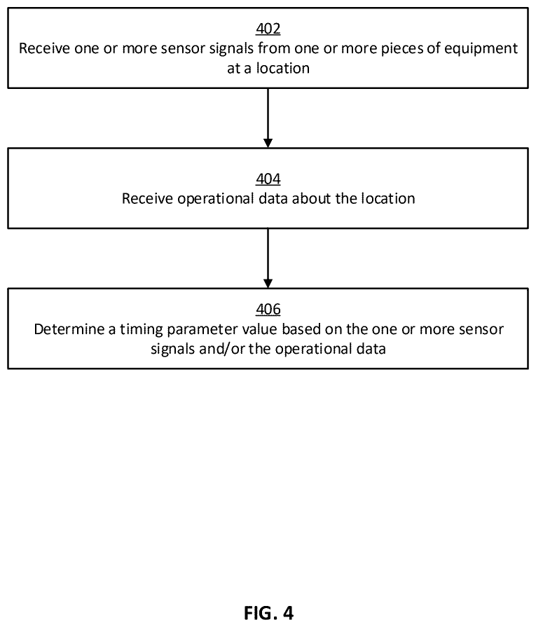

In block 304, the server system 102 computes a first timing parameter value for the request 122. In some examples, the first timing parameter value can be an estimated time to complete the request 122. For instance, the first timing parameter value can be an estimated completion time indicating the time at which one or more of the objects specified in the request will be ready for pickup. The server system 102 can determine the first timing parameter value by executing a predefined algorithm or a trained machine-learning model. In some examples, the server system 102 can execute the process shown in FIG. 4 to compute the first timing parameter value.

In block 306, the server system 102 determines a first priority of the request 122. The first priority of the request 122 is a priority level assigned to the request 122. The server system 102 can determine the first priority of the request 122 based on a predefined prioritization scheme. The predefined prioritization scheme may prioritize requests based on their characteristics, such as their values, origin, and/or communication channel. For example, the predefined prioritization scheme may prioritize requests arriving through certain communication channels or originating from certain locations over others. In one such example, if the request 122 was received via a first communication channel, the request 122 can be assigned a higher priority than a request received through a second communication channel. As another example, if the request 122 originated from inside the location 104, the request 122 can be assigned a higher priority level than requests originating from outside the location 104, or vice versa.

In block 308, the server system 102 selects a first timing threshold based on the first priority of the request 122. In some examples, the server system 102 may include a predefined mapping that correlates priority levels to timing thresholds. The server system 102 can access the mapping to determine which timing threshold corresponds to the first priority, and select that timing threshold in this step. Examples of the first timing threshold may include 4 minutes, 8 minutes, 12 minutes, 15 minutes, 30 minutes, an hour, etc.

In block 310, the server system 102 determines whether the first timing parameter value is greater than the first timing threshold. This may involve comparing the first timing parameter value to the first timing threshold. If so, the process can proceed to block 312. Otherwise, the process can proceed to block 326.

In block 312, the server system 102 determines a next request in the buffer 116. The next request can be the request that immediately precedes the request 122 in the buffer 116, in the sense that the next request is closer to the head of the buffer than the request 122. The server system 102 can determine the next request in the buffer 116 by accessing the buffer 116.

In block 314, the server system 102 computes a second timing parameter value for the next request. In some examples, the second timing parameter value can be an estimated time to complete the next request. For instance, the second timing parameter value can be an estimated completion time indicating the time at which one or more of the objects specified in the next request will be ready for pickup. The server system 102 can determine the second timing parameter value using any of the techniques described above in block 304.

In block 316, the server system 102 determines a second priority of the next request. The second priority of the next request is a priority level assigned to the next request. The second priority of the next request can be the same as or different from the first priority of the request 112. The server system 102 can determine the second priority of the next request using any of the techniques described above in block 306.

In some examples, the server system 102 may determine whether the second priority is equal to the first priority. If so, the process may proceed to block 326.

In block 318, the server system 102 selects a second timing threshold based on the second priority of the next request. The second timing threshold can be the same as or different from the first timing threshold. The server system 102 can determine the second timing threshold using any of the techniques described above in block 308.

In block 320, the server system 102 determines whether the second timing parameter value is less than or equal to the second timing threshold. This may involve comparing the second timing parameter value to the second timing threshold. If so, the process can proceed to block 322. Otherwise, the process can proceed to block 326.

In block 322, the server system 102 swaps the positions of the request 122 and the next request in the buffer 116. As a result, the request 122 will be in the buffer position at which the next request was formerly placed. The process can return to block 304 and repeat based on the new position of the request 122 in the buffer 116.

As noted above, if one or more conditions are satisfied (e.g., the first timing parameter value is less than the first timing threshold, the second timing parameter value is greater than the second timing threshold, and/or the next request is also of the first priority), the process can proceed to block 326. In block 326, the server system 102 determines whether a stopping criterion is met. An example of the stopping criterion may include that at least a certain number (e.g., all) of the requests in the buffer 116 have undergone the shuffling process. If the stopping criterion has not been met, the server system 102 can select another request in the buffer 116 to be shuffled and the process can repeat for that request. Otherwise, the process can end.

Turning now to FIG. 4, shown is a flowchart of an example of a process for computing parameter values using machine learning according to some aspects of the present disclosure. Other examples may involve more operations, fewer operations, different operations, or a different sequence of operations than is shown in FIG. 4. The operations of FIG. 4 are described below with respect to the components of FIG. 1 described above.

In block 402, a server system 102 receives one or more sensor signals from one or more pieces of equipment 110a-c at a location 104, such as a café, restaurant, production plant, or any other location at which physical objects are manufactured. Examples of such objects can include electronics, toys, beverages, food items, etc. In some examples, the sensor signals can indicate the operational status of the pieces of equipment 110a-c. For instance, equipment 110a can transmit a sensor signal to the server system 102 indicating that it is currently operational and/or the task that it is currently performing. Whether a piece of equipment is operational, or the operation that it is currently performing, can serve as a useful proxy for whether the corresponding station 106a is operational and/or the demand on the station 106a. The number of stations 106a-n that are operational and the tasks they are currently performing can, in turn, help indicate the level of throughput that might be possible at the location 104 over a future time window. For example, if more of the stations 106a-c are operational, then the location 104 may achieve a higher throughput over a future time window (e.g., the next one hour). Conversely, if fewer stations 106a-c are operational, then the location 104 may achieve a lower throughput over the future time window.

In block 404, the server system 102 receives operational data about the location 104. The operational data can be any information pertinent to the functioning and condition of the location 104. Examples of the operational data can include the number of stations that are operational, the number of stations that are not operational, the number of workers present at the location 104, the identification and quantity of each piece of equipment present at the location 104, the physical arrangement and positioning of equipment at the location 104, the network connectivity status of each piece of equipment at the location 104, the functional status of each piece of equipment (e.g., whether it requires maintenance, has failed, or is fully operational), the operating hours of the location 104, environmental conditions such as temperature and humidity at the location 104, and energy consumption levels at the location 104. In some examples, the operational data can include historical information, such as usage patterns, demand trends associated with a piece of equipment or the location as a whole over a prior time window, maintenance history, etc.

The server system 102 can receive the operational data from a computing device positioned at the location 104 or elsewhere. The operational data may be manually input into the computing device (e.g., by a worker) or automatically collected by the computing device, for example by communicating with the equipment 110a-c at the location 104. The computing device can then transmit the operational data to the server system 102.

In block 406, the server system 102 determines a timing parameter value based on the one or more sensor signals and/or the operational data. For example, the server system 102 can provide the sensor signals and/or the operational data as input to a trained machine-learning model, which can compute and output the timing parameter value based on the input. As another example, the server system 102 can provide the sensor signals and/or the operational data as input to a trained machine-learning model, which can generate and output a predictive forecast of demand at the location over a future time window based on the input. The server system 102 can then determine the timing parameter value based on the predictive forecast. In this example, the machine-learning model may be a forecasting model such as an exponential smoothing model (ESM), an autoregressive integrated moving average (ARIMA) model, etc. The machine-learning model can be trained on a set of training data, which may include historical usage or demand patterns collected over a prior time window.

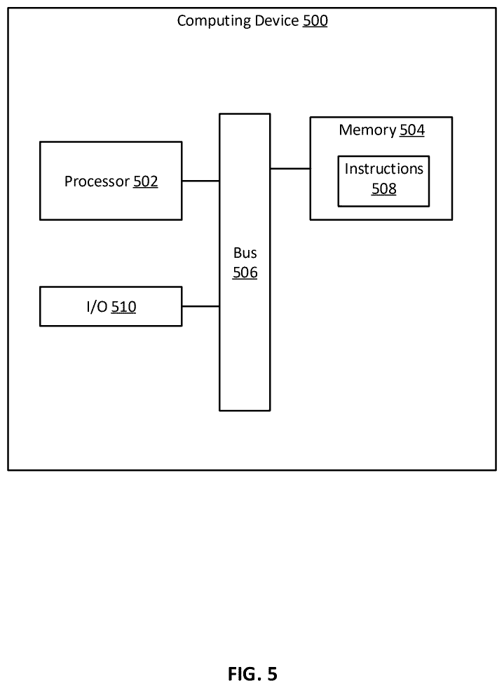

Turning now to FIG. 5, shown is a block diagram of an example of a computing device for implementing some aspects of the present disclosure. In some examples, the computing device 500 may correspond to the server system 102 or the client device 120 of FIG. 1.

The computing device 500 includes a processor 502 communicatively coupled to a memory 504 by a bus 506. The processor 502 can include one processor or multiple processors. Examples of the processor 502 can include a Field-Programmable Gate Array (FPGA), an application-specific integrated circuit (ASIC), or a microprocessor. The processor 502 can execute instructions 508 stored in the memory 504 to perform operations. The instructions 508 may include processor-specific instructions generated by a compiler or an interpreter from code written in any suitable computer-programming language, such as C, C++, C#, Java, or Python.

The memory 504 can include one memory device or multiple memory devices. The memory 504 can be volatile or non-volatile (e.g., it can retain stored information when powered off). Examples of the memory 504 include electrically erasable and programmable read-only memory (EEPROM), flash memory, or cache memory. At least some of the memory 504 includes a non-transitory computer-readable medium from which the processor 502 can read instructions 508. A computer-readable medium can include electronic, optical, magnetic, or other storage devices capable of providing the processor 502 with the instructions 508 or other program code. Examples of a computer-readable mediums include magnetic disks, memory chips, ROM, random-access memory (RAM), an ASIC, a configured processor, and optical storage.

The computing device 500 can also include input/output components 510. Examples of input components can include a mouse, a keyboard, a touchpad, a touch-screen display, or a sensor, such as a global positioning system (GPS) unit, a gyroscope, an accelerometer, an inclinometer, or a camera. Examples of output components can include a visual display such as a liquid crystal display (LCD) or a light-emitting diode (LED) display, an audio display such as a speaker, or a haptic display such as a haptic actuator.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A method comprising:
receiving, by one or more processors, a request of a first priority;
storing, by the one or more processors, the request in a memory buffer associated with a plurality of requests of different priorities;
for each request among the plurality of requests, executing a buffer shuffling process for the request that involves iteratively:
a) computing, by the one or more processors, a first timing parameter value for the request;
b) determining, by the one or more processors, whether the first timing parameter value exceeds a first predefined timing threshold;
c) based on determining that the first timing parameter value exceeds the first predefined timing threshold, determining, by the one or more processors, a next request that is immediately ahead of the request in the memory buffer;
d) determining, by the one or more processors, whether the next request is of a second priority that is lower than the first priority;
e) based on determining that the next request is of the second priority, determining, by the one or more processors, whether a second timing parameter value for the next request is less than a second predefined timing threshold;
f) based on determining that the second timing parameter value for the next request is less than the second predefined timing threshold, moving, by the one or more processors, the request ahead of the next request in the memory buffer; and
g) repeating, by the one or more processors, some or all of steps a)-g) for the request until one or more conditions are satisfied; and
controlling equipment at a location to fulfill each request in a sequence in which the plurality of requests are arranged in the memory buffer.

2. The method of claim 1, wherein the one or more conditions include the first timing parameter value being less than the first predefined timing threshold.

3. The method of claim 1, wherein the one or more conditions include the next request being of the first priority.

4. The method of claim 1, wherein the one or more conditions include the second timing parameter value being greater than or equal to the second predefined timing threshold.

5. The method of claim 1, further comprising:
receiving, by the one or more processors, one or more sensor signals from one or more pieces of equipment at the location; and
determining, by the one or more processors, the first timing parameter value and the second timing parameter value based on the sensor signals.

6. The method of claim 5, further comprising:
executing, by the one or more processors, a trained machine-learning model to generate a predictive forecast of demand at the location over a future time window based on the one or more sensor signals; and
determining, by the one or more processors, the first timing parameter value and the second timing parameter value based on the predictive forecast.

7. The method of claim 1, wherein fulfilling each request involves constructing a physical object associated with the request.

8. The method of claim 1, further comprising:
determining, by the one or more processors, a first object and a second object associated with a particular request in the memory buffer;
after executing the buffer shuffling process, determining, by the one or more processors, a new position of the particular request in the memory buffer as a result of the buffer shuffling process, wherein the particular request was moved from an initial position to the new position during the buffer shuffling process;
based on the new position of the particular request in the memory buffer:
adjusting, by the one or more processors, a position of the first object in a first queue, the first queue being different from the memory buffer; and
adjusting, by the one or more processors, another position of the second object in a second queue, the second queue being different from the first queue and the memory buffer; and
controlling the equipment to construct the first object based on its adjusted position in the first queue and the second object based on its adjusted position in the second queue.

9. The method of claim 8, further comprising:
printing, by the one or more processors using a first printer at a first station in the location, a first set of labels for a first set of objects in the first queue in a first order in which the first set of objects are positioned in the first queue;
controlling the equipment to construct the first set of objects in the first order in which the first set of labels are printed for the first set of objects in the first queue;
printing, by the one or more processors using a second printer at a second station in the location, a second set of labels for a second set of objects in the second queue in a second order in which the second set of objects are positioned in the second queue; and
controlling the equipment to construct the second set of objects in the second order in which the second set of labels are printed for the second set of objects in the second queue.

10. A system comprising:
one or more processors;
one or more memories storing instructions that are executable by the one or more processors for causing the one or more processors to perform operations including:
receiving a request of a first priority;
storing the request in a memory buffer associated with a plurality of requests of different priorities;
for each request among the plurality of requests, executing a buffer shuffling process for the request that involves iteratively:
a) computing a first timing parameter value for the request;
b) determining whether the first timing parameter value exceeds a first predefined timing threshold;
c) based on determining that the first timing parameter value exceeds the first predefined timing threshold, determining a next request that is immediately ahead of the request in the memory buffer;
d) determining whether the next request is of a second priority that is lower than the first priority;
e) based on determining that the next request is of the second priority, determining whether a second timing parameter value for the next request is less than a second predefined timing threshold;
f) based on determining that the second timing parameter value for the next request is less than the second predefined timing threshold, moving the request ahead of the next request in the memory buffer; and
g) repeating some or all of steps a)-g) for the request until one or more conditions are satisfied; and
equipment positioned at a location, the equipment being operable to fulfill each request in a sequence in which the plurality of requests are arranged in the memory buffer.

11. The system of claim 10, wherein the condition involves the first timing parameter value being less than the first predefined timing threshold.

12. The system of claim 10, wherein the one or more conditions include involves the next request being of the first priority.

13. The system of claim 10, wherein the one or more conditions include the second timing parameter value being greater than or equal to the second predefined timing threshold.

14. The system of claim 10, wherein the operations further comprise:
receiving one or more sensor signals from one or more pieces of equipment at the location; and
determining the first timing parameter value and the second timing parameter value based on the sensor signals.

15. The system of claim 14, wherein the operations further comprise:
executing a trained machine-learning model to generate a predictive forecast of demand at the location over a future time window based on the one or more sensor signals; and
determining the first timing parameter value and the second timing parameter value based on the predictive forecast.

16. The system of claim 10, wherein fulfilling each request involves constructing a physical object associated with the request.

17. The system of claim 10, wherein the operations further comprise:
determining a first object and a second object associated with a particular request in the memory buffer;
after executing the buffer shuffling process, determining a new position of the particular request in the memory buffer as a result of the buffer shuffling process, wherein the particular request was moved from an initial position to the new position during the buffer shuffling process;
based on the new position of the particular request in the memory buffer:
adjusting a position of the first object in a first queue, the first queue being different from the memory buffer; and
adjusting another position of the second object in a second queue, the second queue being different from the first queue and the memory buffer; and
wherein the equipment is controllable to construct the first object based on its adjusted position in the first queue and the second object based on its adjusted position in the second queue.

18. The system of claim 17, wherein the operations further comprise:
printing, using a first printer at a first station in the location, a first set of labels for a first set of objects in the first queue in a first order in which the first set of objects are positioned in the first queue; and
printing, using a second printer at a second station in the location, a second set of labels for a second set of objects in the second queue in a second order in which the second set of objects are positioned in the second queue;
wherein the equipment in controllable to construct the first set of objects in the first order in which the first set of labels are printed for the first set of objects in the first queue, and wherein the equipment in controllable to construct the second set of objects in the second order in which the second set of labels are printed for the second set of objects in the second queue.

19. The system of claim 10, wherein the operations further comprise:
receiving the request via a particular request channel from among a plurality of request channels for receiving requests;
determining that the request is of the first priority based on the request being received via the particular request channel; and
storing metadata with the request in the memory buffer, the metadata indicating that the request is of the first priority.

20. A non-transitory computer-readable medium comprising program code that is executable by one or more processors for causing the one or more processors to perform operations including:
receiving a request of a first priority;
storing the request in a memory buffer associated with a plurality of requests of different priorities; and
for each request among the plurality of requests, executing a buffer shuffling process for the request that involves iteratively:
a) computing a first timing parameter value for the request;
b) determining whether the first timing parameter value exceeds a first predefined timing threshold;
c) based on determining that the first timing parameter value exceeds the first predefined timing threshold, determining a next request that is immediately ahead of the request in the memory buffer;
d) determining whether the next request is of a second priority that is lower than the first priority;
e) based on determining that the next request is of the second priority, determining whether a second timing parameter value for the next request is less than a second predefined timing threshold;
f) based on determining that the second timing parameter value for the next request is less than the second predefined timing threshold, moving, the request ahead of the next request in the memory buffer; and
g) repeating some or all of steps a)-g) for the request until a condition is satisfied;
wherein equipment positionable at a location is operable to fulfill each request in a sequence in which the plurality of requests are arranged in the memory buffer.
